(19) United States
(12) Patent Application Publication
(10) Pub. No.: US 2008/0271614 A1
(43) Pub. Date: Nov. 6, 2008

(54) Manual Food Processor

(76) Inventor: Chung Wai Stephen Chan, Hang Kong (CN)

Correspondence Address: J C PATENTS, INC., 4 VENTURE, SUITE 250, IRVINE, CA, 92618, US

(21) Appl. No.: 12/089,157

(22) PCT Filed: Jun. 8, 2006
(86) PCT No.: PCT/CN06/01252

§ 371 Date: Apr. 3, 2008

(30) Foreign Application Priority Data
Dec. 29, 2005 (CN) 200520037382.1

(51) Int. Cl. A47J 43/00

(52) U.S. Cl. 99/537; 241/169.1

(57) ABSTRACT

A manual food processor comprises a main body including a base and an upper cover, wherein the base is formed by an open housing having a cylindrical cavity in which a mounting flange is provided, and the upper cover is fitted on the base and having an opening for feeding food, and a cranking bar hole is provided on a side wall of the main body; a cutter unit including an annular cutter frame on the periphery of which an annular bevel gear is formed and a cutter fixed on the cutter frame, wherein the cutter unit is horizontally mounted on the mounting flange of the base; and a cranking bar unit including a cranking bar, a rotational shaft which is fitted in the cranking bar hole, and a bevel gear which is mounted on a tip of the rotational shaft of the cranking bar and engaged with the annular bevel gear of the cutter frame.

### FIELD OF THE INVENTION

The present invention relates to a food processor, and particularly, to a manual food processor for processing food into desired shapes.

### BACKGROUND OF THE INVENTION

For conveniently processing food into desired shapes, various minitype kitchen appliances have been developed. The most common and simplest one is a planar combined cutter. A user holds food to be processed with a hand and moves it back and forth on a surface of the cutter. Then the shaped food in the form of shreds, strips or slices drops down from the other side of the cutter. Such kind of combined cutters has the advantages of simple structure and low cost; nevertheless, it has a problem of safety. Exposed blades of such cutters often hurt users' fingers. Furthermore, it is hard to process the food with only a small portion left, which would lead to waste of food. Another known food processor is an electric appliance, wherein a cutter is driven to rotate at a high speed by a small motor, thus a mass of food can be processed in a short time. Since such kind of electric food processors generally is expensive and needs external electrical power, applications of those processors are limited to a certain extend. Besides, it is also difficult to clean them after use due to their complicated structures.

In view of the above situation, a manual food processor is commercially available for slicing food such as cheeses, mushrooms and so on, the structure of which is shown in FIG. 1. The manual food processor is provided with two cylinders, i.e. outer cylinder 1′ and cutting cylinder 2′, both of which are coaxially mounted on a support 4′. A handle 3′ is connected with the cutting cylinder 2′, so that the cutting cylinder 2′ can be rotated by rotating the handle 3′ by a user. A feeding opening 5′ through which the food to be processed is supplied is formed on the top of the outer cylinder 1′. Various cutting blades are provided on the surface of the cutting cylinder 2′ for cutting food into desired shapes as the handle is rotated. Both of the outer cylinder 1′ and the cutting cylinder 2′ are open at the other end opposed to the handle 3′, for discharging the processed food through the open ends. On one hand, the manual food processor is simple in structure and cheap in cost compared with the electric food processors; and on the other hand, the manual food processor has improved performance of safety compared with the combined cutters. However, such kind of manual food processors still has some deficiencies. For example, due to the configuration of the outer cylinder and the cutting cylinder, processed food is prone to be caught between them and hard to be cleaned up. Additionally, it consumes time and labor to clean the outer cylinder and the cutting cylinder.

### SUMMARY OF THE INVENTION

In order to overcome the problems in the prior art, the object of the invention is to provide a manual food processor which is manually operated, simply structured, safe and reliable, and convenient for cleaning.

In an effort to realize the above object, the present invention provides a manual food processor a manual food processor, comprising a main body including a base and an upper cover, wherein the base is formed by an open housing having a cylindrical cavity in which a mounting flange is provided, and the upper cover is fitted on the base and has an opening for feeding food, and a cranking bar hole is provided on a side wall of the main body; a cutter unit including an annular cutter frame on the periphery of which an annular bevel gear is formed and a cutter fixed on the cutter frame, wherein the cutter unit is horizontally mounted on the mounting flange of the base; and a cranking bar unit including a cranking bar, a rotational shaft which is fitted in the cranking bar hole, and a bevel gear which is mounted on a tip of the rotational shaft of the cranking bar and engaged with the annular bevel gear of the cutter frame.

The present invention further comprises a food pusher, the shape of which matches that of the opening for feeding food. For the convenience of operation, the base further comprises a handle projecting outward from the base; and the food pusher includes a pressing rod, an end of which is hinged with an outer end of the handle.

In another embodiment of the invention, a surface of the food pusher contacting with food is provided with patterns to increase friction.

In a further embodiment of the invention, the manual food processor further comprises a receiving container assembled on the lower end of the base.

In a further embodiment of the invention, the cranking bar unit further includes a hole cover mounted on the rotational shaft to cover the cranking bar hole.

Compared with the conventional manual food processors, the practical manual food processor according to the present invention can gather processed food more easily, and its open type design makes cleaning of the processor become easier.

### BRIEF DESCRIPTION OF THE DRAWINGS

The invention will be described in more detail with reference to the following drawings, in which:

FIG. 1 is a longitudinal sectional view of a conventional manual food processor;

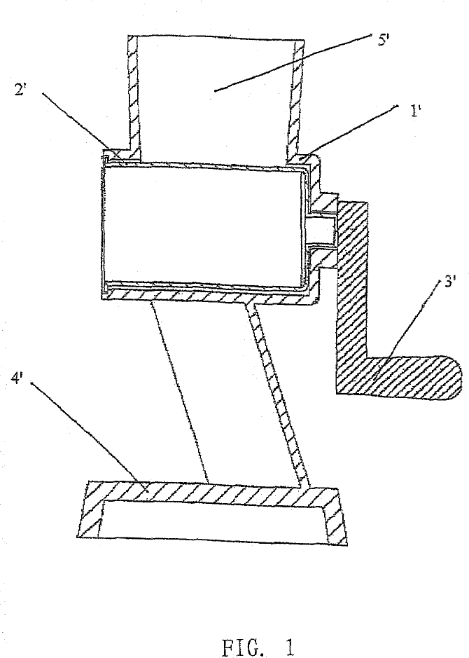

FIG. 2 is a perspective view of a manual food processor according to the present invention;

FIG. 3 is a diagrammatic view of the manual food processor shown in FIG. 2 with the cranking bar being detached;

FIG. 4 is a diagrammatic view of the manual food processor shown in FIG. 2 with the upper cover being disassembled;

FIG. 5 is an exploded perspective view of the manual food processor according to the present invention; and

FIG. 6 is a diagrammatic view of an alternative cutter applied in the manual food processor according to the invention.

### DETAILED DESCRIPTION OF THE INVENTION

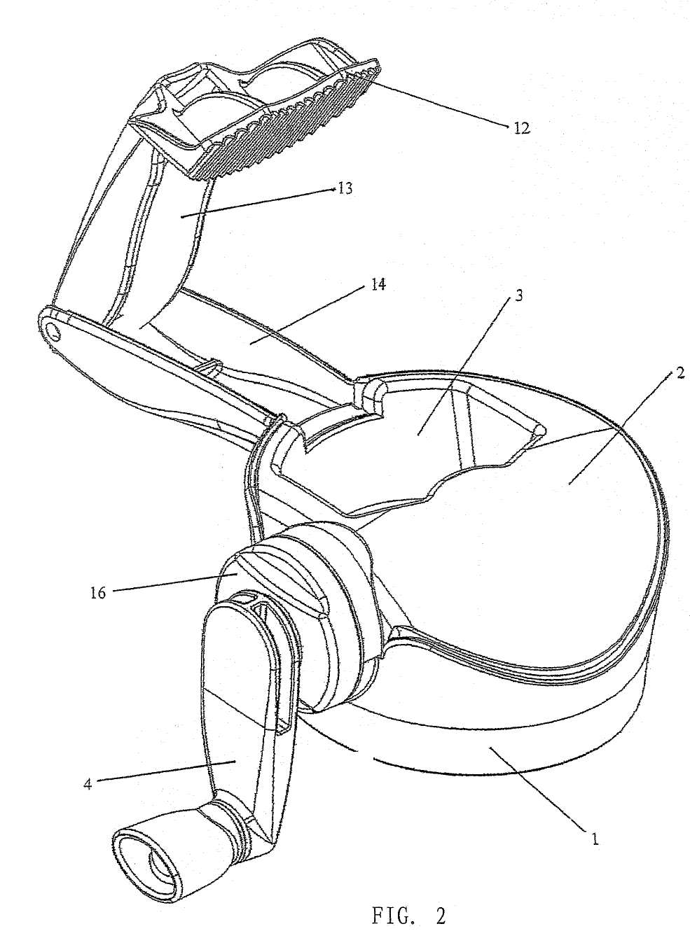

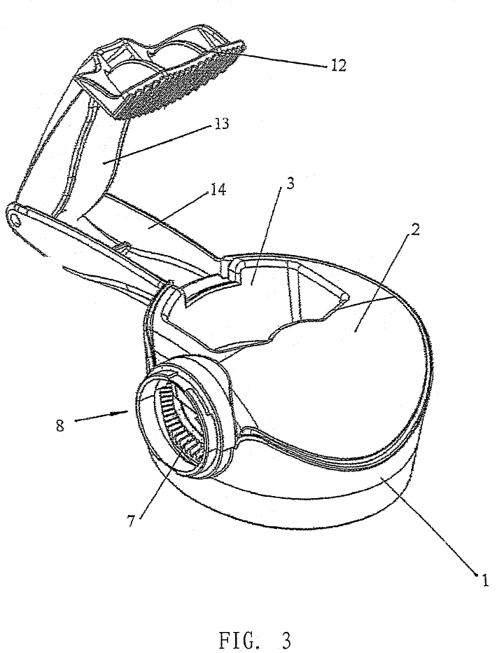

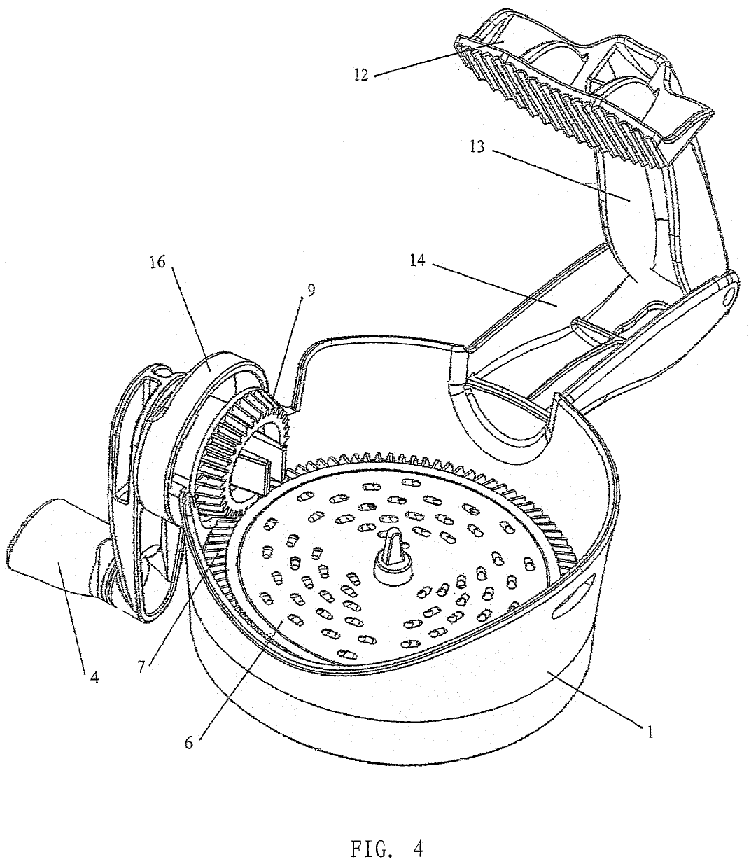

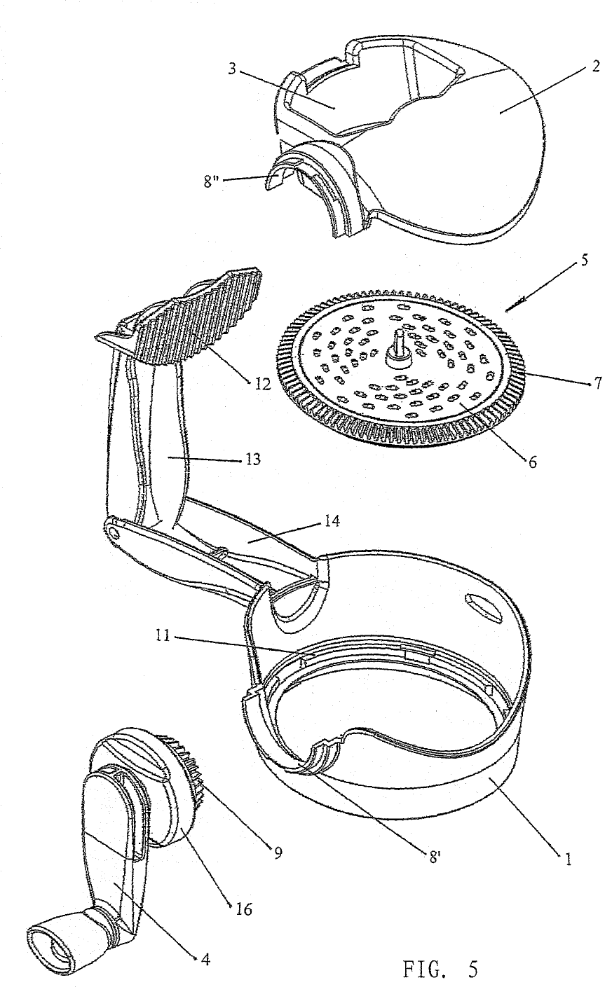

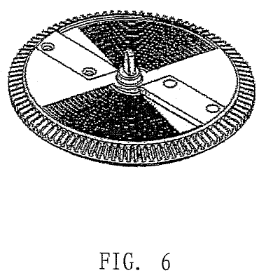

As shown in FIG. 2 to 5, a main body of a manual food processor according to the present invention comprises a base 1 and an upper cover 2. The base 1 is a cylindrical housing which is open in both the upper end and the lower end. The upper cover 2 is fitted on the base 1 and has an opening 3 for feeding food. A mounting flange 11 is provided on an inner wall of the base 1 for supporting and fitting a cutter unit 5. The cutter unit 5 includes an annular cutter frame 7 on which an annular bevel gear is formed and a cutter 6 in a shape of circular plate fixed on the cutter frame 7. In an embodiment shown in FIG. 3 to 5, cutting blades for cutting food into shreds are formed on the cutter 6. An alternative cutter 6 is shown in FIG. 6, on which cutting blades for cutting food into slices are formed. Obviously, those skilled in the art could design cutters applied in the manual food processor of the present invention according to various known cutting blades for processing food.

A cranking bar hole 8, in which a cranking bar 4 of the manual food processor is fitted, is provided on a side wall of the main body of the manual food processor. The cranking bar hole 8 can be entirely formed within the base 1, or alternatively, as the embodiment shown in the figures, the integral hole 8 may be provided by combining a part 8′ and a part 8″ respectively formed in the base 1 and the upper cover 2.

The cranking bar 4 includes a rotational shaft which is inserted into the cranking bar hole 8 and around which the cranking bar 4 can rotate. The cranking bar 4 is provided so as to drive the cutter 6, and a bevel gear 9 is therefore formed on a tip of the rotational shaft of the cranking bar 4. The bevel gear 9 engages with the annular bevel gear formed on the cutter frame 7. A hole cover 16 is mounted on the rotational shaft to cover the cranking bar hole 8 from outside.

When the cranking bar 4 is rotated by a user, the rotation of the cranking bar 4 in a vertical plane is converted into the rotation of the cutter 6 in a horizontal plane by engagement of the bevel gear 9 and the annular bevel gear. When food is filled through the feeding opening 3, it is cut into desired shapes by the cutter 6, whose moving direction is perpendicular to the feeding direction of food, and then drops directly from the open lower portion of the base 1. A receiving container (not shown) can be assembled at the lower portion of the base 1 for gathering processed food conveniently.

The food needs to be pressed when the food is supplied through the feeding opening 3, in order to ensure a sufficient feeding force to realize an effective cutting. Thus, a food pusher is provided with a shape matching that of the feeding opening for pressing the food. The food pusher can be an independent element separating from the main body of the manual food processor, or alternatively, as shown in the embodiment in the figures, it can be an element connected with the main body of the manual food processor. In the embodiment shown in FIG. 2 to 4, a food pusher 12 has an elongated pressing rod 13, an end of which is hinged with an end of a handle 14 projecting from the base 1. The shape of the pressing rod 13 matches that of the handle 14. In use, the user rotates the cranking bar 4 by one hand, and grasps the handle 14 and pressing rod 13 that are assembled together by the other hand, so that the gripping force is transmitted to the food pusher 12 at the tip of the pressing rod 13 to provide feeding force for food. With the height of food being shortened by continuous cutting, the food pusher 12 keeps descending until it entirely enters into the feeding opening, which indicates that food has been processed. Various patterns can be provided on a surface of the food pusher 12 directly contacting with food for increasing friction and preventing skidding.

The plate-configuration of the cutter in the present invention is simple and easy to clean compared with that of the cylindrical-configuration cutter in the prior art. Additionally, the manual food processor according to the present invention further has the advantages of safety and reliability.

The present invention has been described in detail with reference to the preferred embodiments, whereas, the invention is not limited to that. It should be understood by those skilled in the art that various additional modifications and changes can be made without departing from the spirit and scope of the present invention.

1. A manual food processor, comprising:
a main body including a base and an upper cover, wherein the base is formed by an open housing having a cylindrical cavity in which a mounting flange is provided, and the upper cover is fitted on the base and has an opening for feeding food, and a cranking bar hole is provided on a side wall of the main body;
a cutter unit including an annular cutter frame on the periphery of which an annular bevel gear is formed and a cutter fixed on the cutter frame, wherein the cutter unit is horizontally mounted on the mounting flange of the base; and
a cranking bar unit including a cranking bar, a rotational shaft which is fitted in the cranking bar hole, and a bevel gear which is mounted on the tip of the rotational shaft of the cranking bar and engaged with the annular bevel gear of the cutter frame.

2. The manual food processor according to claim 1, wherein the manual food processor further comprises a food pusher, the shape of which match that of the opening for feeding food.

3. The manual food processor according to claim 2, wherein the base further comprises a handle projecting outward from the base; and the food pusher includes a pressing rod an end of which is hinged with an outer end of the handle.

4. The manual food processor according to claim 2, wherein a surface of the food pusher contacting with food is provided with patterns to increase friction.

5. The manual food processor according to claim 1, wherein the manual food processor further comprises a receiving container assembled on the lower end of the base.

6. The manual food processor according to claim 1, wherein the cranking bar unit also includes a hole cover mounted on the rotational shaft to cover the cranking bar hole.

7. The manual food processor according to claim 2, wherein the manual food processor further comprises a receiving container assembled on the lower end of the base.

8. The manual food processor according to claim 3, wherein the manual food processor further comprises a receiving container assembled on the lower end of the base.

9. The manual food processor according to claim 3, wherein a surface of the food pusher contacting with food is provided with patterns to increase friction.

10. The manual food processor according to claim 2, wherein the cranking bar unit also includes a hole cover mounted on the rotational shaft to cover the cranking bar hole.

11. The manual food processor according to claim 3 wherein the cranking bar unit also includes a hole cover mounted on the rotational shaft to cover the cranking bar hole.
